(19) United States
(12) Patent Application Publication
(10) Pub. No.: US 2020/0139883 A1
(43) Pub. Date: May 7, 2020

(54) SMART ILLUMINATION DOOR PANEL-BACKGROUND

(71) Applicant: Continental Automotive Systems, Inc., Auburn Hills, MI (US)

(72) Inventor: Arthur S. Brown, Sterling Heights, MI (US)

(21) Appl. No.: 16/180,683

(22) Filed: Nov. 5, 2018

(51) Int. Cl. B60Q 3/217; B60R 13/02; B60Q 3/54; B60Q 3/60; B60Q 1/32

(52) U.S. Cl. CPC B60Q 3/217; B60R 13/0243; B60Q 2500/10; B60Q 3/60; B60Q 1/323; B60Q 3/54

(57) ABSTRACT

A door panel for a motor vehicle provides diffuse lights by locating lights inside the door and “covering” them with a light-transmissive substrate that is covered by a soft-touch outer skin layer that is also light transmissive.

Vehicle interiors typically use soft-touch or cast skin surfaces that provide cushion and deflection to contact. Vehicle interior illumination is typically provided by assemblies inserted into, these soft-surfaces. The illuminating light source is typically visible. In some vehicles, illumination is intentionally indirect, and the lighting assemblies are located such that other components conceal the illumination source from the vehicle occupants, and the visible light is directed onto a specific surface the effect of which is merely visible light that does not create stylized graphics or patterns that fill an area. A door panel or other interior surface that can provide light would be different and an improvement over prior art illumination devices and methods.

### BRIEF DESCRIPTION OF THE FIGURES

FIG. 1 illustrates a generic conventional door panel with illumination effects;

FIG. 2 illustrates the door panel of FIG. 1 with its hidden illumination effects in an OFF state;

FIG. 3 illustrates a smart illumination door panel with its hidden illumination effects in an ON state;

FIG. 4 illustrates a generic door panel with a conventional safety indication for when the door is open and shows the illumination effects used for safety indication in a door open condition;

FIG. 5 is an exploded view illustrating the component of the smart illumination door panel.

### DETAILED DESCRIPTION

Put simply, this disclosure describes a door panel that has smart illumination effects with no visible lighting assemblies. One embodiment is a door panel that appears conventional and which uses several soft-touch surfaces. Unlike typical soft-touch areas, the soft-touch surfaces can be illuminated themselves for providing illumination that can be used to support existing advanced driver assist system (ADAS) features, such as blind spot monitoring, in which portions of the door panel are illuminated when a vehicle is present in the blind spot. The soft-touch surface illumination also supports proposed ADAS features, such as a HALO system, which uses an LED to provide perimeter lighting near a window line to help direct other-vehicle driver attention. The soft-touch surface illumination can also provide a safety indication, especially for low light or night conditions. While a door is open, an area of the soft-touch surface illumination panel can be illuminated to be visible to those outside the vehicle, such as occupants in other vehicles. The soft-touch surface illumination can also provide a means to improve visibility inside the vehicle when the door is closed as part of a welcome sequence.

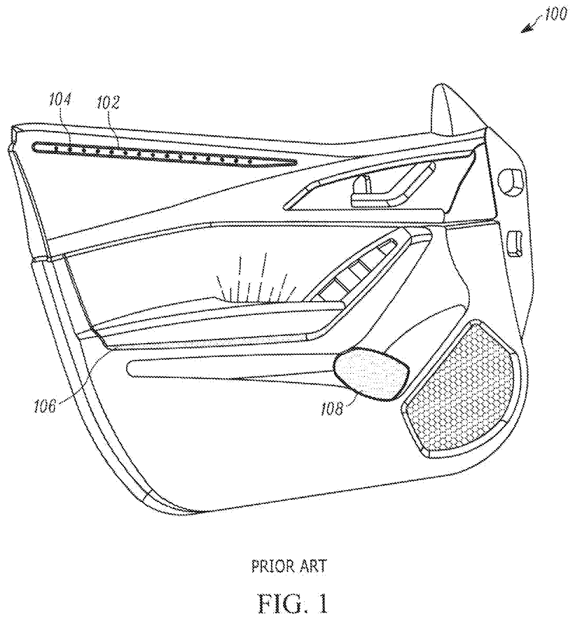

FIG. 1 illustrates a generic conventional door panel 100 with conventional illumination provided by a set of conventional lights 102, 106, 108 typically provided by incandescent lamps or light emitting diodes. As can be seen in the figure, the conventional lights 102, 106, 108 provide illumination that is essentially discrete, individual point sources of light 104, narrow strip-like illuminations 106 or a flood light 108, which as used herein is a broad-beamed, relatively high-intensity light emitted from a relatively narrow point.

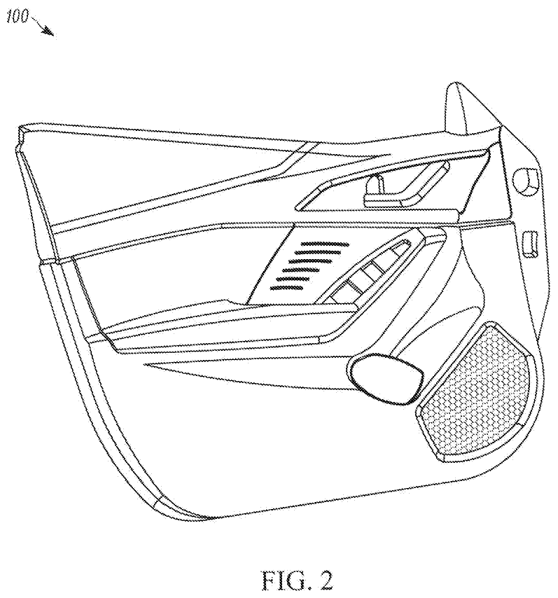

FIG. 2 illustrates the generic door panel of FIG. 1 albeit with the lights 102, 106, 108 turned off.

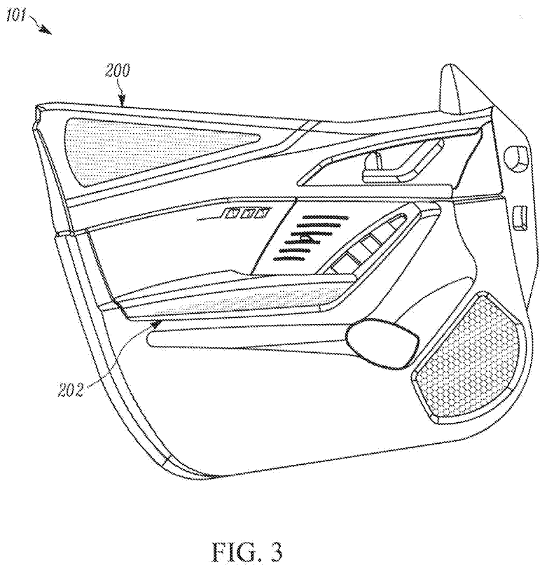

FIG. 3 illustrates a first embodiment of smart illumination door panel 101 with soft-touch surface illumination 200, 206 in an ON state. Diffuse lighting 200 and 206 identify the top-left corner of the panel 101 and the door handle respectively.

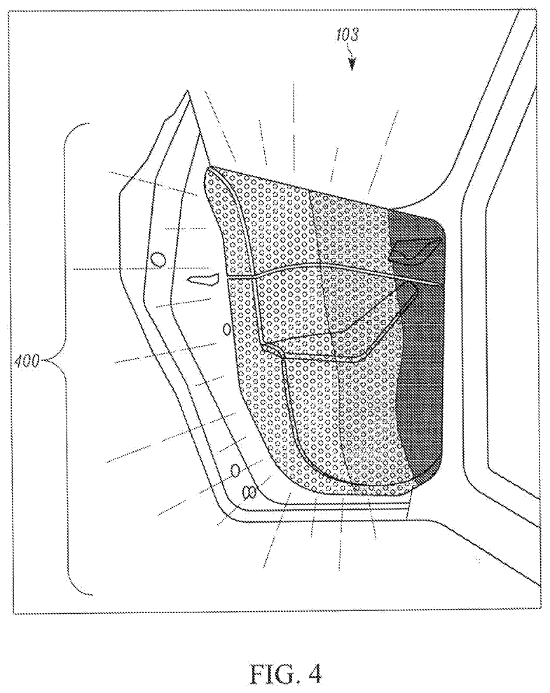

FIG. 4 illustrates a second embodiment of a smart illumination door panel 103. Most of the left-half of the panel 103 is provided with soft-touch surface illumination 400 in an ON state.

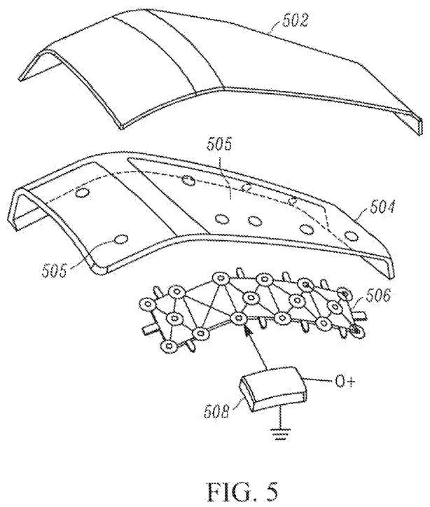

Referring now to FIG. 5, an exploded view of a smart illumination door panel is provided. The smart illumination door panel comprises a specialized surface skin 502, which is soft and which allows the transmission of light from a source 504 beneath the skin 502. The skin 502 is preferably a material made by and available from Benecke-Kaliko AG.

The skin 502 covers a substrate 504, which defines the surface shape of the panel 100 best seen in FIGS. 1-4. In one embodiment, the substrate 504 is a flexible, light-transmissive and light-diffusing plastic. In other embodiments, the substrate 504 is rigid. In yet other embodiments, the substrate 504 can be either flexible or rigid but provided with numerous perforations or windows 505 of varying shapes and sizes, which allow light from light sources “below” the substrate to pass through them. In yet another embodiment, the substrate 504 is opaque but with perforations or windows 505 that allow light to pass through them. Regardless of the material from which the substrate is made, the skin 502 is applied to the substrate 504 by casting or mechanically wrapping and adhering in position.

The substrate 504 is either molded from a completely clear material, a semi-transparent or translucent material or it is molded in a way that at least portions of the substrate are selectively transparent or perhaps perforated to allow light to pass through to the skin 502.

As used herein, the term “pattern” means an artistic or graphic design or form. The substrate 504 could also include perforations that form a pattern of that appear through or modify the appearance of the illumination from the light sources through the skin 502.

An array of light emitting diodes or incandescent lamps 506 below and attached to the substrate 504 are powered by a controller 508, which is preferably powered by the vehicle. The light emitting diodes/incandescent lamps 506 can be either monochromatic or polychromatic as a design choice in order to provide illumination the color of which can be uniform or multiple colors. The illumination can be an area fill, or a specialized pattern. Patterns can be static or animated by the control of individual light elements or the output of a display.

The foregoing description is for purposes of illustration. The true scope of the invention is set forth in the following claims

1. An illuminated door panel for a motor vehicle comprising:
an outer skin layer comprising a light-transmissive soft-touch material;
a substrate coupled to the outer skin layer;
a plurality of light sources coupled to the substrate, the substrate including perforations to allow light from the plurality of light sources to pass through the substrate; and
a controller coupled to the plurality of light sources.

2. The illuminated door panel of claim 1, wherein the substrate is light transmissive.

3. The illuminated door panel of claim 1, wherein the substrate is light-diffusing.

4. The illuminated door panel of claim 1, wherein the substrate is opaque and perforated.

5. The illuminated door panel of claim 1, wherein the perforations form a pattern.

6. The illuminated door panel of claim 1, wherein the substrate is a substantially rigid plastic.

7. The illuminated door panel of claim 1, wherein the substrate is a flexible plastic.

8. The illuminated door panel of claim 1, wherein the substrate is substantially clear.

9. (canceled)

10. The illuminated door panel of claim 1, wherein the controller and plurality of light sources are powered by the motor vehicle.

11. The illuminated door panel of claim 1, wherein plurality of light sources comprise an array of light emitting diodes attached to across a surface of the substrate opposite the outer skin layer.

12. The illuminated door panel of claim 1, wherein the perforations on the substrate are disposed on the substrate to form a pattern that defines an appearance of illumination from the plurality of light sources through the outer skin layer.

13. The illuminated door panel of claim 1, wherein the plurality of light sources are polychromatic to provide illumination in more than one color.

14. The illuminated door panel of claim 1, wherein the plurality of light sources are disposed in a pattern across the substrate.

15. The illuminated door panel of claim 1, wherein the plurality of light sources are animated by control of individual ones of the plurality of light sources.
